(19) United States
(12) Patent Application Publication
(10) Pub. No.: US 2010/0181927 A1
(43) Pub. Date: Jul. 22, 2010

(54) MULTI-LAMP DRIVING CIRCUIT

(75) Inventors: CHI-HSIUNG LEE, Jhongli City (TW); CHIH-CHANG CHANG, Jhongli City (TW); YING-HUNG LIU, Jhongli City (TW)

Correspondence Address: PCE INDUSTRY, INC.;ATT. Steven Reiss, 288 SOUTH MAYO AVENUE, CITY OF INDUSTRY, CA, 91789, US

(73) Assignee: AMPOWER TECHNOLOGY CO., LTD., Jhongli City (TW)

(21) Appl. No.: 12/618,903

(22) Filed: Nov. 16, 2009

(30) Foreign Application Priority Data
Jan. 16, 2009 (CN) 200920129515.6

(51) Int. Cl. H05B 41/16

(52) U.S. Cl. 315/255

(57) ABSTRACT

A multi-lamp driving circuit includes a power supply, a booster converter including a first winding and a second winding, a plurality of current balance circuits and a plurality of balance converters. The first winding of the booster converter is coupled to the power supply. Each of the current balance circuits includes a plurality of current balance sub-circuits each including a capacitor and a lamp connected in series. One end of each of the current balance sub-circuits is connected to one end of the second winding of the booster converter. A first winding of each of the balance converters is electrically connected between the other end of the second winding of the booster converter and the other end of the current balance sub-circuits of corresponding current balance circuits. Second windings of the balance converters are connected in series.

### BACKGROUND

1. Technical Field

The disclosure relates to display devices, and particularly to a multi-lamp driving circuit for a backlight module of a liquid crystal display (LCD) device.

2. Description of Related Art

Discharge lamps are commonly employed as backlights in liquid crystal display (LCD) devices. In larger liquid crystal display (LCD) devices, such as televisions, a plurality of discharge lamps are often employed to achieve better lighting and meet practical brightness requirements. In practice, current through the plurality of discharge lamps are difficult to normalize due to varying electrical characteristics of the lamps, which results in uneven brightness for the LCD devices.

A commonly used multi-lamp driving circuit directs converters disposed between two ends of the lamps to balance current through the lamps, with one lamp connected to one converter therein. However, with an increase in the number of lamps, the number of converters increases correspondingly, resulting in increased device size and cost.

Therefore, a need exists in the industry to overcome the described limitations.

### BRIEF DESCRIPTION OF THE DRAWINGS

FIG. 1 is a schematic diagram of a multi-lamp driving circuit in accordance with a first exemplary embodiment of the present disclosure.

FIG. 2 is a schematic diagram of a multi-lamp driving circuit in accordance with a second exemplary embodiment of the present disclosure.

FIG. 3 is a schematic diagram of a multi-lamp driving circuit in accordance with a third exemplary embodiment of the present disclosure.

FIG. 4 is a schematic diagram of a multi-lamp driving circuit in accordance with a fourth exemplary embodiment of the present disclosure.

FIG. 5 is a schematic diagram of a multi-lamp driving circuit in accordance with a fifth exemplary embodiment of the present disclosure.

### DETAILED DESCRIPTION

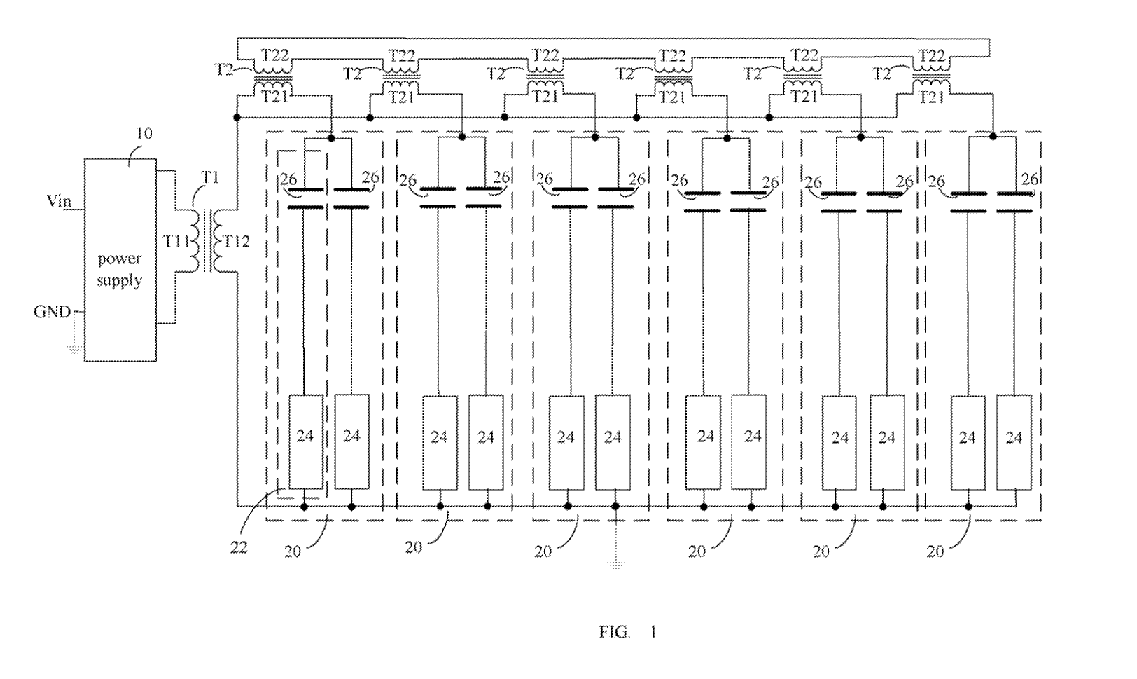

Referring to FIG. 1-FIG. 5, a multi-lamp driving circuit of the present disclosure includes a power supply 10 operable to provide electrical signals, a booster converter T1 including a first winding T11 and a second winding T12, a plurality of current balance circuits 20 and a plurality of balance converters T2. The first winding T11 of the booster converter T1 is coupled to the power supply 10 and configured to convert the electrical signals into driving signals. Each of the current balance circuits 20 includes a plurality of current balance sub-circuits 22 each including a capacitor 26 and a lamp 24 connected in series. One end of each of the current balance sub-circuits 22 is connected to one end of the second winding T12 of the booster converter T1. The plurality of balance converters T2 each include a first winding T21 and a second winding T22. The first winding T21 of each of the balance converters T2 is electrically connected between the other end of the second winding T12 of the booster converter T1 and the other end of the current balance sub-circuits 22 of corresponding current balance circuits 20. The second windings T22 of the balance converters T2 are connected in series so as to form a loop circuit. Quantities of the lamps 24 of the plurality current balance circuits 20 are the same.

FIG. 1 is a schematic diagram of the multi-lamp driving circuit in accordance with a first exemplary embodiment of the present disclosure. In this embodiment, the multi-lamp driving circuit adapted to drive twelve lamps 24 includes six current balance circuits 20 and six balance converters T2. Each current balance circuit 20 includes two current balance sub-circuits 22 each including a capacitor 26 and one of the lamps 24. The lamps 24 are grounded and connected to a low voltage terminal of the second winding T12 of the booster converter T1.

The booster converter T1 converts the electrical signals from the power supply 10 into driving signals. The plurality of balance converters T2 receive the driving signals. Current through the second windings T22 of the balance converters T2 are substantially equal due to the second windings T22 of the balance converters T2 being connected in series in the loop circuit. Therefore, the input current of the plurality current balance circuits 20 are substantially equal. In each current circuit 20, the capacitors 26 balance the current through the lamps 24.

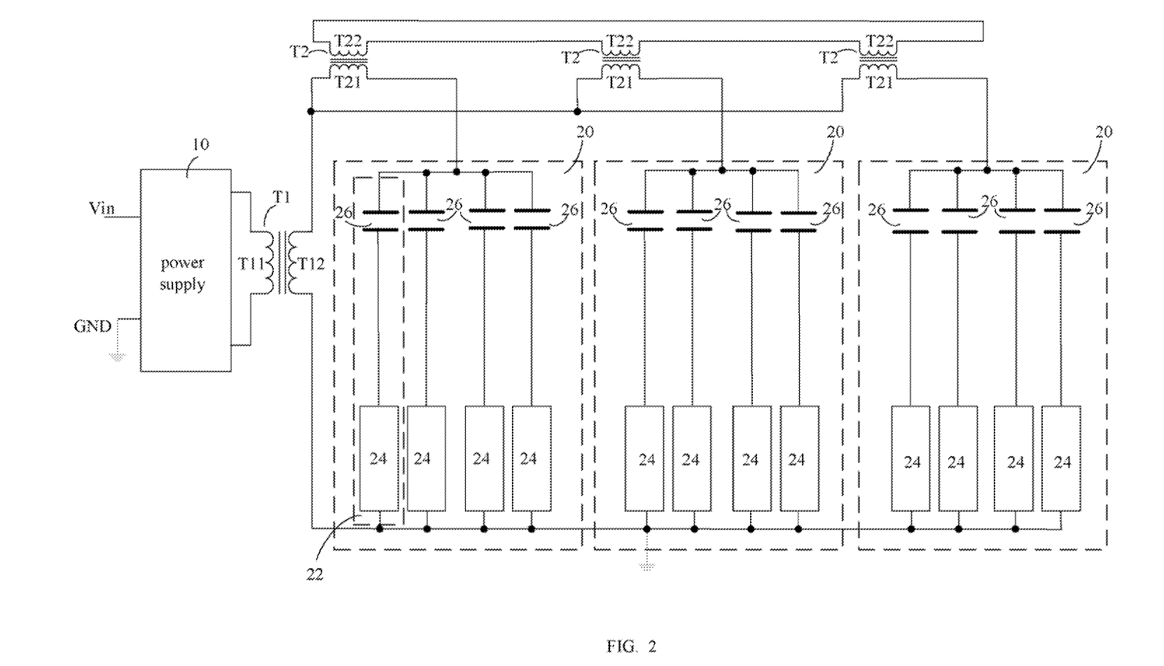

FIG. 2 is a schematic diagram of the multi-lamp driving circuit in accordance with a second exemplary embodiment of the present disclosure. In this embodiment, the multi-lamp driving circuit adapted to drive twelve lamps 24 includes three current balance circuits 20 and three balance converters T2. Each current balance circuit 20 includes four current balance sub-circuits 22 each including a capacitor 26 and one of the lamps 24.

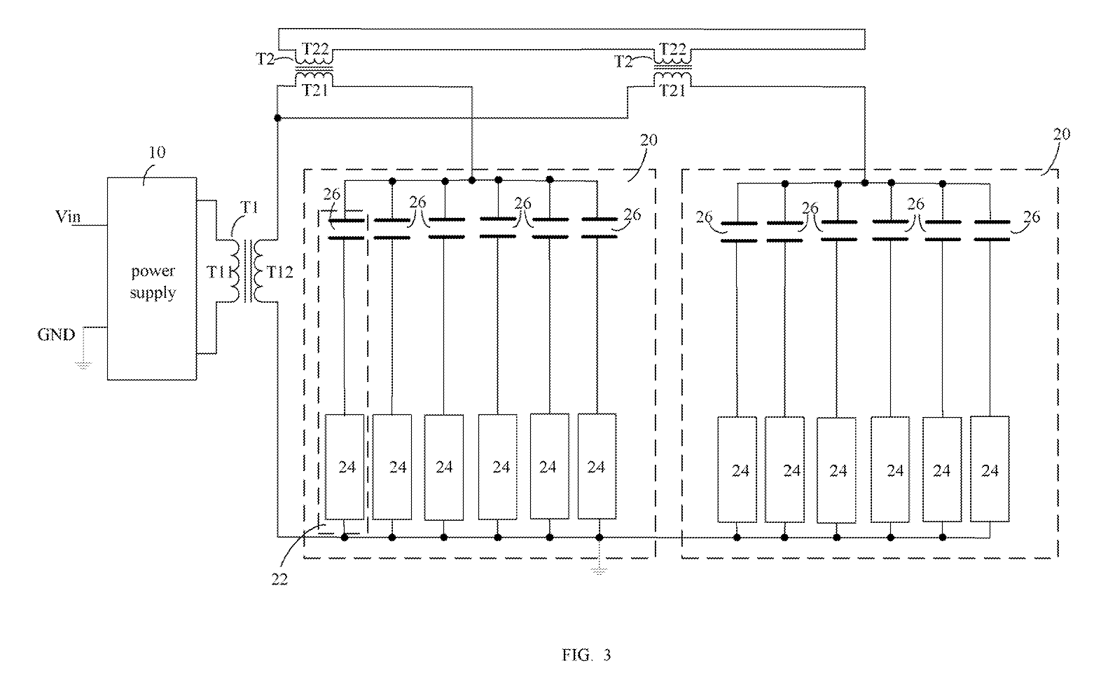

FIG. 3 is a schematic diagram of the multi-lamp driving circuit in accordance with a third exemplary embodiment of the present disclosure. In this embodiment, the multi-lamp driving circuit adapted to drive twelve lamps 24 includes two current balance circuits 20 and two balance converters T2, which results in a decreased number of balance converters T2 and a reduced device size. Each current balance circuit 20 includes six current balance sub-circuits 22 each including a capacitor 26 and one of the lamps 24.

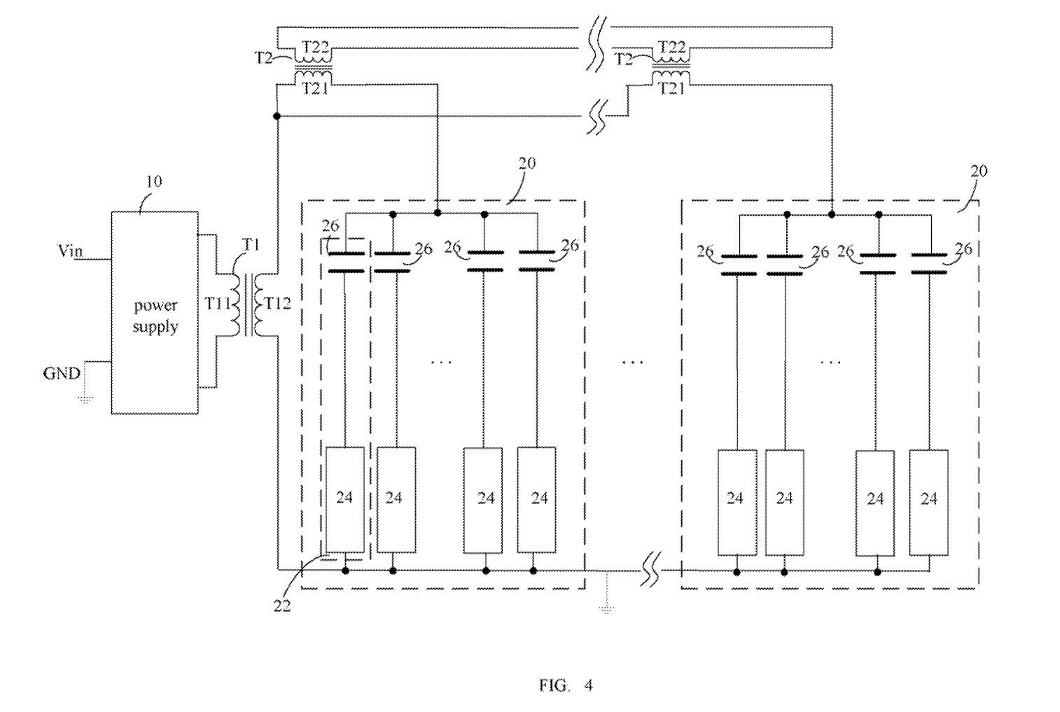

FIG. 4 is a schematic diagram of the multi-lamp driving circuit in accordance with a fourth exemplary embodiment of the present disclosure. In this embodiment, the multi-lamp driving circuit adapted to drive a plurality of lamps 24 includes two or more current balance circuits 20 and two or more balance converters T2 to adapt to multiple user requirements. Each current balance circuit 20 includes current balance sub-circuits 22 each including a capacitor 26 and one of the lamps 24. The lamps 24 are connected to a low voltage terminal of the second winding T12 of the booster converter T1

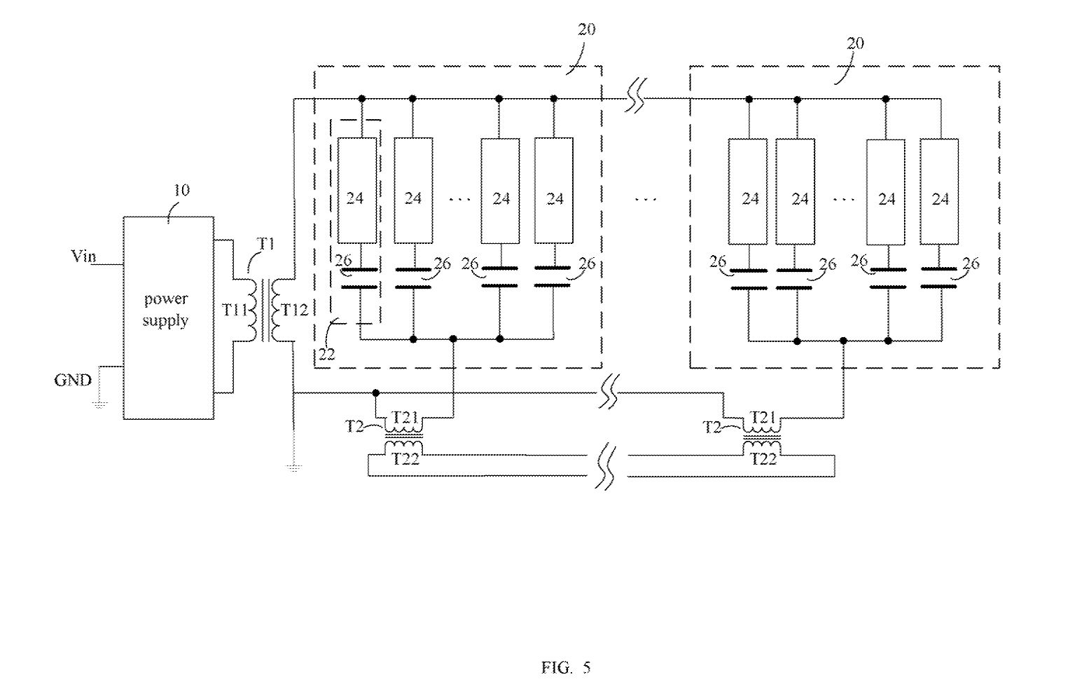

FIG. 5 is a schematic diagram of the multi-lamp driving circuit in accordance with a fifth exemplary embodiment of the present disclosure, differing from that of the fourth exemplary embodiment in that the balance converters T2 are grounded and connected to the low voltage terminal of the second winding T12 of the booster converter T1, and the lamps 24 are connected to a high voltage terminal of the second winding T12 of the booster converter T1.

In the embodiments, since current through the each of the balance converters T2 are balanced, and the current through each of the current balance circuits 20 are balanced, thus, the current through the lamps 24 are correspondingly balanced.

It is believed that the exemplary embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A multi-lamp driving circuit adapted to drive a plurality of lamps, comprising:
a power supply operable to provide electrical signals;
a booster converter with a first winding coupled to the power supply, and configured to convert the electrical signals into driving signals able to drive the plurality of lamps;
a plurality of current balance circuits, each comprising a plurality of current balance sub-circuits each comprising a capacitor and one of the plurality of lamps connected in series, wherein one end of each of the current balance sub-circuits is connected to one end of a second winding of the booster converter; and
a plurality of balance converters each comprising a first winding and a second winding, wherein the first winding of each of the balance converters is electrically connected between the other end of the second winding of the booster converter and the other end of the current balance sub-circuits of corresponding current balance circuits, and the second windings of the balance converters are connected in series so as to form a loop circuit.

2. The multi-lamp driving circuit of claim 1, wherein quantities of the lamps of the plurality current balance circuits are the same.

3. The multi-lamp driving circuit of claim 2, wherein the lamps are grounded and connected to a low voltage terminal of the second winding of the booster converter.

4. The multi-lamp driving circuit of claim 2, wherein the balance converters are grounded and connected to the low voltage terminal of the second winding of the booster converter.
